(19) United States
(12) Patent Application Publication
(10) Pub. No.: US 2024/0418077 A1
(43) Pub. Date: Dec. 19, 2024

(54) NULL POINT DEPTH CALIBRATION

(71) Applicant: The Charles Machine Works, Inc., Perry, OK (US)

(72) Inventor: Scott B. Cole, Edmond, OK (US)

(21) Appl. No.: 18/819,294

(22) Filed: Aug. 29, 2024

Related U.S. Application Data
(63) Continuation of application No. 17/881,804, filed on Aug. 5, 2022, now Pat. No. 12,078,053.
(60) Provisional application No. 63/231,055, filed on Aug. 9, 2021.

(51) Int. Cl. E21B 47/092; E21B 7/04; G01V 3/08; G01V 3/38

(52) U.S. Cl. CPC E21B 47/092; E21B 7/046; G01V 3/081; G01V 3/38

(57) ABSTRACT

A calibration method for calibrating an underground beacon and tracker system for use with horizontal directional drilling. The beacon emits a magnetic field, which is received at an above-ground receiving antenna. The antenna is used to locate front and rear null points in the emitted field. The vertical and horizontal offset between the null points is determined to locate the beacon. Then, the magnetic field strength is determined at one of the null points. This value may be used to calculate or update a calibration constant. The calibration constant is then used in subsequent locating step while the characteristics of the underground environment surrounding the beacon remain similar.

### SUMMARY

The present invention is directed to a method. The method comprises advancing a drill string carrying a beacon to a first underground location, emitting an electromagnetic signal from the beacon and performing a calibration procedure. The calibration procedure comprises detecting a first null point and a second null point with a receiving antenna at an above ground location, determining a distance between the first null point and the second null point and storing the distance in a memory, receiving a signal indicative of a pitch of the beacon, determining a signal strength at the selected one of the first null point and the second null point, using the pitch and the signal strength to determine a calibration constant, and storing the calibration constant in a memory.

In another aspect, the invention is directed to a method. The method comprises emitting an electromagnetic field from a beacon at a below ground location, detecting the electromagnetic field at a tracking antenna at an above ground area, and determining a first null field location on a surface of the ground. The method further comprises determining a second null field location on the surface of the ground, detecting a strength of the electromagnetic field at a selected one of the first null field location and the second null field location, and from the first null field location, the second null field location, and the strength of the electromagnetic field, determining a calibration constant with the beacon at the below ground location.

### BRIEF DESCRIPTION OF THE DRAWINGS

FIG. 1 is a diagrammatic representation of a horizontal directional drilling machine which is driving a drill string in an underground environment. The drill string supports a downhole tool assembly at its distal end. The assembly comprises a bit and housing. A beacon is housed within the housing and emits a dipole magnetic field into the underground environment which is detectable at an above ground location. A tracker is used to determine the location of the beacon.

FIG. 2 shows an underground beacon emitting a magnetic field. The magnetic field has front and rear null points. A tracker operator is shown on the ground surface using a tracker to find the front and rear null points. A GPS satellite is shown emitting a signal that can be used by the tracker to determine its absolute location.

FIG. 3 is a diagram providing a legend for the various geometric variables involved in performing the calibration method. The beacon is shown at its underground location, with front and rear null points shown as well. In FIG. 3, the “x” direction is a vertical direction, while the “z” direction is a horizontal, or longitudinal, direction along the bore path. A distance “r” is the true distance between the beacon and a particular point. Δx and Δz refer to the difference in the “x” and “z” directions between the null points.

### DETAILED DESCRIPTION

In horizontal directional drilling applications, a steerable boring tool 10 is used as a part of a downhole tool assembly. The boring tool 10 may comprise a bit 12, such as a slant-faced bit, which enables the steering of the boring tool 10. The boring tool 10 will include a housing 14 that contains a beacon 16. The tool 10 is at an underground location at a distal end 18 of a drill string 20. The drill string 20 is made up of multiple pipe segments 22, and advanced and rotated by a horizontal directional drilling machine 24.

To steer the boring tool 10, it is important to know the location and orientation (roll, pitch and yaw) of the beacon 16. Various beacons 16 have been developed to provide an operator with information concerning the location and orientation of the downhole tool assembly 12. This information is transmitted via electromagnetic signal to an above ground tracker 30. In particular, roll, pitch, and yaw may be detected by on-board sensors located at the boring tool 10. Alternatively, some orientation of the boring tool 10 may be determined based upon the drill string 20 clock orientation as measured at the horizontal directional drill 24.

Location of a boring tool is determined by using the tracker 30. The beacon 16 emits an electromagnetic dipole field which the tracker 30 detects in three dimensions using an onboard tracking antenna. Such a tracking antenna may be that disclosed and discussed in U.S. Pat. No. 7,647,987, issued to Cole, or U.S. Pat. No. 11,204,437, issued to Cole, et. al., the contents of which are incorporated herein by reference.

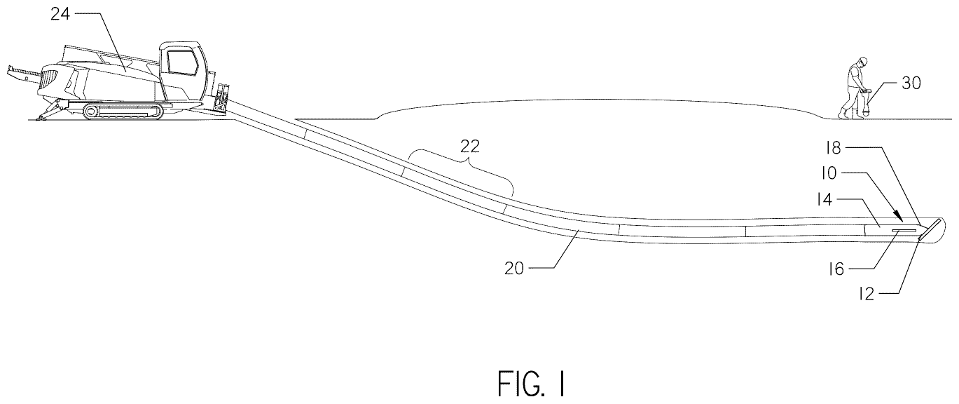

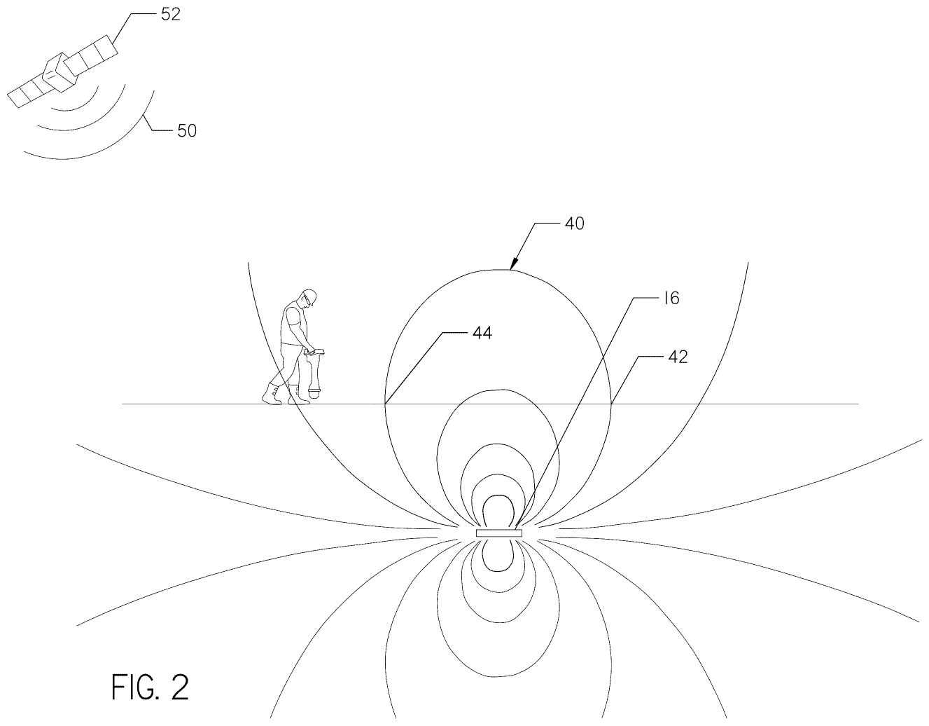

In general, as shown in FIG. 2, a tracking operation is conducted by placing the tracker 30 within electromagnetic dipole field 40 emitted by the beacon 16. The dipole field 40 will have “null points” along the path of the drill string 20 (FIG. 1) in two locations. It should be understood that a “null point”, in the industry, refers to a point at which the horizontal components of the electromagnetic field are negligible across a vertical plane. In FIG. 2, these points are represented by the location where the field's tangent is vertical. One such point is in front of the beacon along a projected bore path, referred to as a front null 42. Another such point is behind the beacon, above the drill string, referred to as a rear null 44. Detection of the field strength at the null points 42, 44 aids in the determination of the location of the beacon 16, and therefore, the boring tool 10 (FIG. 1).

The absolute location of the tracker 30 may be determined by a GPS signal 50 emitted by one or more satellites 52. A method for determining the absolute location of the beacon 16 utilizing the GPS signal is provided in U.S. Pat. No. 11,397,266, issued to Cole, et. al., the contents of which are incorporated herein by reference.

To provide accurate location and orientation information it is important that the tracker 30 and beacon 16 assembly are properly calibrated with one another. Calibration typically includes adjusting the intensity or signal strength of the output signal of the beacon 16 to be sufficiently detected by the tracker 30. A typical procedure for calibrating a beacon is disclosed in U.S. Pat. No. 7,331,409, the entire contents of which are incorporated herein by reference.

Calibration is typically performed after placing a beacon 16 within a housing 14, but prior to beginning a drilling operation. In one method of configuring the signal strength of the beacon's output signal, the tracker 30 and housing 14 are directly aligned and positioned a known distance, preferably ten feet, from each other. The tracker 30 then uses the strength of the beacon's output signal and the known distance between the tracker 30 and the beacon 16 to calculate a constant “k” in the below equation:

$$B = k / {d}^{3}$$

Where,
B=the strength of the magnetic field detected by the tracker 30;
d=the distance between the tracker 30 and beacon 16; and
k=a constant that is stored by the tracker 30 for subsequent measurements to determine the distance between the tracker and housing 14.

The constant “k” is used by the tracker 30 during drilling operations to determine the precise depth of the beacon 16. The above equation can be used to solve for “k” if the tracker 30 is directly over or directly in-line with the beacon 16. When calibration is performed prior to starting drilling operations, the operator can be sure that the tracker 30 is directly in-line with the beacon 16.

In the underground environment, however, multiple factors may lead to an inaccurate depth reading between the tracker 30 and beacon 16 during a drilling operation. This may especially be true as beacon 16 depth becomes greater and soil conditions change. For example, a soil with an increased concentration of ferrous material or boring under salt water may cause the “k” value determined from the calibration to be less accurate. If the operator suspects that conditions exist that are producing inaccurate depth readings, a method is needed to recalibrate the tracker 30 to the beacon 16 during boring operations to account for the underground environment.

The present invention provides a method of recalibrating the tracker 30 to the beacon 16 after a drilling operation has begun and the beacon is underground. In contrast to traditional calibrating methods, the operator may not know if the tracker 30 is directly over or directly in-line with the beacon 16, and the precise distance between the tracker 30 and the beacon 16 or precise depth of the beacon is unknown. Because of these unknown factors, the traditional method of calibration by using the equation by

$$B = k / {d}^{3}$$

is less applicable.

The present invention provides a method for re-calibrating the tracker 30 to the beacon 16 by measuring the position and distance between known points within the electromagnetic field 40 using the null points 42, 44.

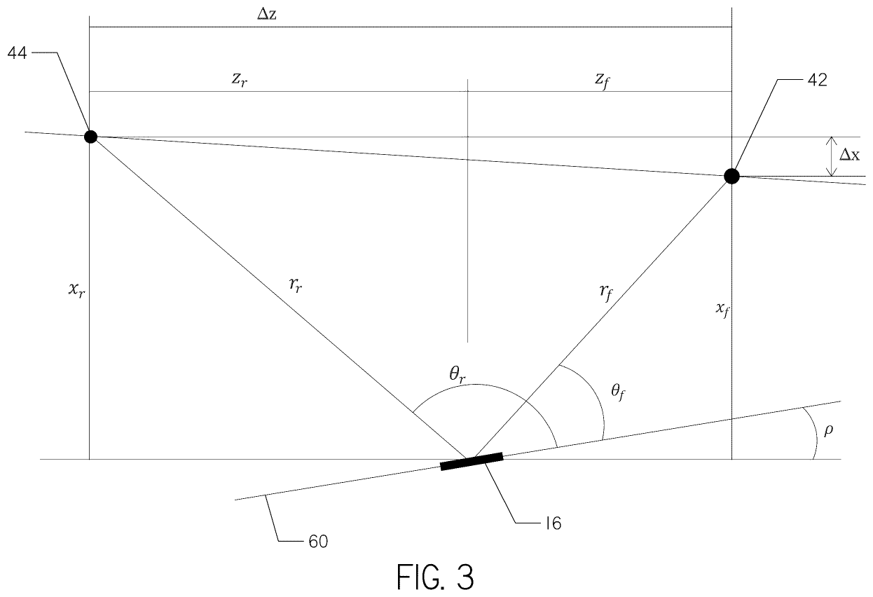

With reference now to FIG. 3, when the ground is flat, the front null 42, rear null 44, and beacon 16 form an isosceles triangle. Thus, the precise depth of the beacon 16 may be found by the equation d=Δz/sqrt(2), where “d” is the depth of the beacon and “Δz” is the distance between the front and rear null points. The preceding equation is only applicable when the pitch p of the downhole tool assembly is zero and the elevation at each null point is equal.

In reality, the “depth” will likely be different at each null point by a difference Δx. If the pitch p does not equal to zero, the depth is found by the equation:

$${x}_{f} = \frac{Δ z + Δ x \cdot cot ( {θ}_{r} + ρ )}{cot ( {θ}_{f} + ρ ) - cot ( {θ}_{r} + ρ )}$$

Where,
x_{f}=the precise depth between the beacon 16 and the front null point 42;
Δz=the horizontal distance between the front 42 and rear 44 null points;
Δx=the depth offset between the null points 42, 44 if the terrain is not level;
θ_{f}=the included angle between the front null point 42 and a longitudinal axis 60 of the beacon 16;
θᵣ=the included angle between the rear null point 44 and a longitudinal axis 60 of the beacon 16; and
p=the pitch of the beacon 16 as detected by sensors at the beacon 16.

If the terrain is not constant, it can be accounted for as a depth offset Δx and can be measured by GPS, a laser level, altimeter, etc. If the terrain is level, Δx in the above equation will equal zero.

θ_{f} and θᵣ in the above equation can be found using the below equations, the mathematical proofs of which can be found in Exhibit “A” to U.S. Provisional Patent Application No. 63/231,055, to which this application claims priority, the contents of which are incorporated by reference herein.

$${θ}_{f} = \frac{1}{2} ( - ρ + {cos}^{- 1} ( - \frac{cos ( ρ )}{3} ) ) \\ {θ}_{r} = π - \frac{ρ}{2} - \frac{1}{2} \cdot {cos}^{- 1} ( - \frac{cos ( ρ )}{3} )$$

Utilizing the preceding equations, the tracker 30 operator may determine the precise depth of the beacon 16 by locating and measuring the distance between the null points 42, 44.

The method may include locating and digitally marking with GPS coordinates at a first one of the front 42 and rear 44 null point using the GPS signal 50. The operator may then locate and digitally mark with GPS coordinates at a second of the front 42 and rear 44 null point. The tracker 30 onboard processor may then automatically calculate the distance Δz between the front 42 and rear 44 null points, and thereby determine the precise depth of the beacon 16. Alternatively, the tracker 30 operator may manually measure and enter the distance between the null points 42, 44.

Once the precise depth between the front null point 42 and the beacon 16 or “x_{f}”′ of the beacon is determined, the fact that the tracker 30 is not directly over the beacon needs to be accounted for. To do this, “x/” can be used to solve for the radial distance “r_{f}” between the tracker 30 at the first null point 42 and the beacon 16 using the Pythagorean equation:

$${r}_{f}^{2} = {x}_{f}^{2} + {z}_{f}^{2}$$

Where,
x_{f}=the vertical distance between the front null point 42 and the beacon 16;
z_{f}=the horizonal distance between the front null point 42 and beacon 16; and
r_{f}=the radial distance between the front null point 42 and the beacon 16.

In the above equation, z can be found using the equation:

$${z}_{f} = \frac{{x}_{f}}{tan ( {θ}_{f} + ρ )}$$

Where,
z_{f}=the horizonal distance between the front null point 42 and beacon 16;
x_{f}=the vertical distance between the front null point 42 and the beacon 16;
θ_{f}=the included angle between the front null point 42 and a longitudinal axis 60 of the beacon 16; and
p=the pitch of the beacon 16.

Once “r_{f}” is found, the tracker 30 may be re-calibrated by solving for “k” in the below equation:

$${B}_{T} = \frac{k}{{r}_{f}^{3}} \cdot \frac{1}{\sqrt{2}} \cdot \sqrt{3 \cdot cos ( 2 {θ}_{f} ) + 5}$$

The above equation can be re-written as:

$$k = \frac{\sqrt{2} \cdot {B}_{T} \cdot {r}_{f}^{3}}{\sqrt{3 \cdot cos ( 2 {θ}_{f} ) + 5}}$$

In the above equation:
B=the strength of the magnetic field 40 detected by the tracker 30 at the front null point 42;
k=a constant that is stored by the tracker 30 for subsequent measurements to determine distance between the tracker 30 and beacon 16;
r_{f}=the radial distance between the front null point 42 and the beacon 16; and
θf=the included angle between the front null point 42 and a longitudinal axis 60 of the beacon 16.

Once a new “k” value is determined, the new “k” value may be stored in a memory by the tracker 30 and subsequently used for measuring the precise location of the beacon 16 as the boring tool 10 is advanced by the drill string 20. It will be appreciated that once the tracker 30 is properly calibrated, it is no longer necessary to locate both the front 42 and rear 44 null points to precisely determine the depth of the beacon using methods known in the art.

As underground conditions change, the calibration process may be repeated. It may also be preferable to configure the tracker 30 to store more than one “k” value. For instance, once a problematic soil condition has been traversed, it may be preferable to simply recalibrate the tracker 30 using a prior stored “k” value.

In additional embodiments, the precise depth of the beacon 16 may be determined by using a distance “rᵣ” between the beacon 16 and the rear null point 44, instead of the front null point 42. Likewise, the above equations may be calculated using the rear null point 44, instead of the front null point 42, where applicable and preferred. For example, it may be that one of the front 42 and rear 44 null points is inaccessible or difficult for tracker placement.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A tracking system, comprising:
at least one receiving antenna configured to detect a direction and magnitude of a magnetic field;
a processor comprising a memory, in communication with the at least one receiving antenna, the processor configured to perform steps comprising:
receiving a first signal from the at least one receiving antenna indicative of the location of a first null point in the magnetic field and a second signal indicative of the location of a second null point in the magnetic field;
receiving a distance between the first null point and the second null point;
determining a signal strength at a selected one of the first null point and the second null point;
using at least the distance and the signal strength to determine a calibration constant; and
storing the calibration constant in the memory.

2. The tracking system of claim 1, wherein the processor receives the distance between the first null point and the second null point from a manual measurement.

3. The tracking system of claim 1, wherein the distance between the first null point and the second null point comprises a horizontal distance and a vertical distance.

4. The tracking system of claim 1 further comprising a GPS signal receiver.

5. The tracking system of claim 4 wherein the processor is configured to determine an absolute position of the first null point and the second null point using the GPS signal receiver.

6. The tracking system of claim 5 in which the processor receives the distance between the first null point and the second null point from the determination of the absolute position of the first null point and the second null point.

7. The tracking system of claim 4 wherein the distance between the first null point and the second null point is received from the GPS signal receiver.

8. The tracking system of claim 1, wherein the processor is configured to receive a signal indicative of a pitch of an underground antenna, wherein the magnetic field emanates from the underground antenna.

9. The tracking system of claim 1 comprising a housing, wherein the at least one receiving antenna and the processor are disposed within the housing.

10. A system, comprising:
the tracking system of claim 1; and
an underground beacon, comprising a transmitting antenna, wherein the transmitting antenna emits the magnetic field.

11. The system of claim 10, wherein the beacon further comprises an orientation sensor, the orientation sensor configured to detect a pitch of the beacon.

12. The system of claim 11, wherein:
the pitch of the beacon is placed on the first signal; and
the processor receives the pitch of the beacon from the first signal.

13. The system of claim 10, further comprising a drill string, wherein the underground beacon is disposed on the drill string.

14. A tracker, comprising:
at least one receiving antenna configured to detect a direction and magnitude of an electromagnetic dipole field in three dimensions;
a processor comprising a memory, in communication with the at least one receiving antenna, the processor configured to:
in a first mode, determine a depth and position of an underground source of the electromagnetic dipole field relative to the receiving antenna; and
in a second mode, calibrate the tracker using steps comprising:
determine, from the at least one receiving antenna, a location of a first null point and a second null point in the electromagnetic dipole field;
receiving a distance between the first null point and the second null point;
receiving a depth offset between the first null point and the second null point;
determining a signal strength at a selected one of the first null point and the second null point using the at least one receiving antenna;
using at least the distance, the depth offset, and the signal strength to calculate a calibration constant; and
storing the calibration constant in the memory.

15. The tracker of claim 14, wherein the calibration constant is used by the processor when determining the depth and position of the underground source in the first mode.

16. A system, comprising:
the tracker of claim 14; and
an underground beacon disposed on a drill string, wherein the electromagnetic dipole field emanates from the underground beacon.

17. The tracker of claim 14 wherein the tracker is configured to operate in a third mode, wherein the processor calibrates the tracker in the third mode using steps comprising:
retrieving a known distance and known orientation from the memory;
detecting the signal strength of the electromagnetic field;
using at least the known distance, the known orientation, and the signal strength to calculate a calibration constant; and
storing the calibration constant in the memory.

18. A method of using the tracker of claim 17, comprising:
prior to drilling operations, placing the tracker in the third mode;
with the tracker in the third mode, determining the calibration constant;
beginning drilling operations, wherein a beacon emits the electromagnetic field and is disposed underground;
thereafter, operating the tracker in the first mode to determine a location of the beacon;
thereafter, operating the tracker in the second mode while the beacon is disposed underground;
with the tracker in the second mode, determining the calibration constant; and
thereafter, operating the tracker in the first mode to determine a location of the beacon.

19. A method of using the tracker of claim 14, comprising:
identifying a soil condition which increases error in the determined depth and position of the underground source; and
thereafter, placing the tracker in the second mode; and
while in the second mode, calculating the calibration constant.

20. The tracker of claim 14 further comprising a GPS signal receiver, wherein the processor is configured to receive the distance between the first null point and the second null point from the GPS signal receiver.

21. The tracker of claim 14 wherein the processor is configured to receive the distance between the first null point and the second null point from a manual entry.

22. A system, comprising:
a beacon, disposed within a beacon housing at an underground location, the beacon comprising a transmitting antenna configured to transmit an electromagnetic dipole field;
a tracker, the tracker comprising a receiving antenna, the receiving antenna configured to determine a direction and strength of the electromagnetic dipole field;
wherein the tracker is defined by a calibration constant; and
the tracker is configured to modify the calibration constant using a method comprising:
determining a position of a first null point in the electromagnetic dipole field and a position of a second null point in the electromagnetic dipole field using the receiving antenna;
determining a distance, in three dimensions, between the position of the first null point and the position of the second null point;
determining the strength of the electromagnetic dipole field at a selected one of the first null point and the second null point; and
using the determined strength of the electromagnetic dipole field and the determined distance between the first null point and the second null point, calculating a new calibration constant; and
storing the new calibration constant in a memory.

23. The system of claim 22 wherein the tracker comprises a GPS signal receiver.

24. The system of claim 22 wherein the method further comprises the step of moving from the position of the first null point to the position of the second null point to determine the distance between the position of the first null point and the position of the second null point.

25. The system of claim 22 wherein the beacon comprises a pitch sensor, and wherein the pitch of the beacon is encoded on the electromagnetic dipole field.
